(19) United States
(12) Patent Application Publication
(10) Pub. No.: US 2016/0132485 A1
(43) Pub. Date: May 12, 2016

(54) SYSTEM AND METHOD FOR CONSTRUCTING MORPHEME DICTIONARY BASED ON AUTOMATIC EXTRACTION OF NON-REGISTERED WORD

(71) Applicant: Electronics and Telecommunications Research Institute, Daejeon (KR)

(72) Inventors: Chung Hee LEE, Daejeon (KR); Hyun Ki KIM, Daejeon (KR); Pum Mo RYU, Daejeon (KR); Yong Jin BAE, Daejeon (KR); Hyo Jung OH, Daejeon (KR); Soo Jong LIM, Daejeon (KR); Joon Ho LIM, Daejeon (KR); Myung Gil JANG, Daejeon (KR); Mi Ran CHOI, Daejeon (KR); Jeong HEO, Daejeon (KR)

(21) Appl. No.: 14/939,016

(22) Filed: Nov. 12, 2015

(30) Foreign Application Priority Data
Nov. 12, 2014 (KR) 10-2014-0156951

(51) Int. Cl. G06F 17/27

(52) U.S. Cl. CPC G06F 17/2735; G06F 17/2755; G06F 17/277

(57) ABSTRACT

A system and method for constructing a morpheme dictionary based on an automatic extraction of a non-registered word is provided. A non-registered word is automatically extracted based on a language-independent non-registered word automatic extraction method, and performance of a dictionary and a morpheme analysis is verified based on an automatic estimation by constructing a morpheme dictionary based on the automatically extracted non-registered word. Since the morpheme dictionary is constructed using only a dictionary in which a final verification is passed and it is helpful to improve the performance, the morpheme analysis can be properly performed on the non-registered word of a new field or a new word which newly appears as time passes.

### CROSS-REFERENCE TO RELATED APPLICATION

This application claims priority to and the benefit of Korean Patent Application No. 10-2014-0156951, filed on Nov. 12, 2014, the disclosure of which is incorporated herein by reference in its entirety.

### BACKGROUND

1. Field of the Invention

The present invention relates to a system and method for constructing a morpheme dictionary, and more particularly, to a system and method for constructing a morpheme dictionary capable of improving performance of a morpheme analysis with respect to a new field by extracting a non-registered word from documents of the new field and constructing a morpheme dictionary including the extracted non-registered word.

2. Discussion of Related Art

A morpheme represents a minimum unit having a meaning in linguistics, and a morpheme analyzer performs a function of analyzing a text in the most proper morpheme unit. The morpheme analyzer may be generally classified as a method based on a rule and a dictionary and a method based on machine learning.

In one paper “MACH: A Supersonic Korean Morphological Analyze (K. S. Shim and J. H. Yang, 2002) which is related to the morpheme analysis, a method of outputting every morpheme candidate which is available for each word phrase based on a dictionary, and selecting the most suitable one candidate for a peripheral context based on a rule had been proposed.

The method achieves excellent morpheme analysis performance when the rule and the dictionary are well constructed since the field is limited. However, since the rule and the dictionary are manually constructed, the method has a disadvantage in which the expense is very heavy and the performance is lowered.

In another paper “Part-of-Speech Tagging for Twitter: Annotation, Features, and Experiments (Kevin Gimpel, Nathan Schneider, Brendan O'Connor, Dipanjan Das, Daniel Mills, Jacob Eisenstein, Michael Heilman, Dani Yogatama, Jeffrey Flanigan, and Noah A. Smith, 2011)” which is related to the morpheme analysis, technology of manually constructing learning data in which a morpheme analysis result is tagged, extracting peripheral context information from the learning data as materials and learning a classification model, and analyzing the morpheme had been proposed.

The method has an advantage of excellent morpheme analysis performance when learning data is well constructed, and has an advantage capable of performing a morpheme analysis for various fields without correcting an engine a lot when only the learning data for a new field is well constructed. However, since the heavy expense for manually constructing the learning data is required, the method has a problem in which performance is lowered when the field is actually changed.

Technology disclosed in U.S. Pat. No. 8,275,607 titled “Semi-supervised part-of-speech tagging” which is a patent related to the morpheme analysis allocates a part of speech for each word based on a dictionary, obtains a Bayesian probability value using peripheral context information as materials with respect to words which are not in the dictionary, and allocates the most suitable part of speech.

The method still has a problem in which the performance is lowered when the field is changed since the method needs the dictionary and a learning set which are manually constructed.

The papers and patent related to the morpheme analysis described above properly performs the morpheme analysis on the words of fields which are constructed with data, but have a problem in which the morpheme analysis is not properly performed on a non-registered word shown when the field is changed or a non-registered word which is newly introduced when a time goes by.

There is a prior art document of automatically extracting a newly-coined word or a non-registered word titled “Design and implementation of new word investigation program of finding new word and describing its meaning and managing it” (Kim Dong-Ui and Lee Sang-Gon, 2013).

The study collects press materials such as news, classifies words of the collected documents into initial consonant/medial/final consonant, and draws up a word list by automatically removing a suffix and a postposition. Further, the study draws up a non-registered word list by removing a title word of a Korean standard unabridged dictionary and words listed in a conventional new word list from the words which are drawn up. Moreover, the study manually confirms whether words listed in the non-registered word list which is drawn up are the non-registered word.

However, the method has a problem in which it cannot be applied to another language as it is since it should keep a list related to the suffix and postposition in advance, and has a problem in which a lot of time and costs are needed in order to extract the non-registered word since it automatically extracts a non-registered word candidate but manually determines whether the non-registered word candidate is a final non-registered word.

### SUMMARY OF THE INVENTION

The present invention is directed to a system and method of constructing a morpheme dictionary based on an automatic extraction of a non-registered word capable of performing a morpheme analysis on the non-registered word of a new field or a new word which newly appears as time goes by properly by extracting the non-registered word in a language-independent method and constructing a morpheme dictionary based on the extracted non-registered word.

According to one aspect of the present invention, there is provided a system for constructing a morpheme dictionary based on an automatic extraction of a non-registered word, including: a non-registered word extraction unit configured to generate a first non-registered word dictionary based on a frequency of the non-registered word included in a collected document, and generate a second non-registered word dictionary through a pattern analysis of a context including the non-registered word included in the first non-registered word dictionary; a non-registered word verification unit configured to allocate a weight value to the non-registered word included in the first non-registered word dictionary and the second non-registered word dictionary, and generate a third non-registered word dictionary according to the allocated weight value; and a morpheme dictionary construction unit configured to perform a morpheme analysis of a first estimation set using the third non-registered word dictionary, generate a second estimation set according to a result of the morpheme analysis, and generate a morpheme dictionary according to a result of the morpheme analysis of the second estimation set.

The non-registered word extraction unit may extract tokens having the same type from the collected document, remove a word which is previously registered in a dictionary among the extracted tokens, and store the token in which an extracted frequency is within a predetermined range among remaining tokens in the first non-registered word dictionary.

The non-registered word extraction unit may search for a sentence including the non-registered word included in the first non-registered word dictionary, generate contexts located in left and right sides of the non-registered word in the searched sentence as a pattern, search for a sentence including the same pattern as the generated pattern, and extract the non-registered word which is located in the same position as the non-registered word included in the first non-registered word dictionary in the searched sentence. Further, the non-registered word extraction unit may remove a word which is previously registered in a dictionary among the extracted non-registered words, and store the non-registered word in which an extracted frequency is within a predetermined range among remaining non-registered words in the second non-registered word dictionary.

The non-registered word extraction unit may repeatedly perform an operation of generating the first non-registered word dictionary and the second non-registered word dictionary until the non-registered word is not extracted from the collected document.

The non-registered word verification unit may calculate a score of each non-registered word by multiplying the frequency of the non-registered word included in the first non-registered word dictionary and the second non-registered word dictionary and the allocated weight value, and store the non-registered word in which the calculated score is equal to or more than a predetermined value in the third non-registered word dictionary.

The morpheme dictionary construction unit may generate the second estimation set by converting a noun morpheme of the first estimation set into words included in the third non-registered word dictionary when the result of the morpheme analysis of the first estimation set using the third non-registered word dictionary is not lower than a previous analysis result of the first estimation set, and generate the third non-registered word dictionary as the morpheme dictionary when the result of the morpheme analysis of the second estimation set using the third non-registered word dictionary is greater than a previous analysis result of the second estimation set.

According to another aspect of the present invention, there is provided a method for constructing a morpheme dictionary based on an automatic extraction of a non-registered word, including: extracting the non-registered word included in a collected document; verifying the extracted non-registered word, and generating a non-registered word dictionary; performing a morpheme analysis of a estimation set using the generated non-registered word dictionary; and constructing the generated non-registered word dictionary as the morpheme dictionary according to a result of the morpheme analysis.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a system for constructing a morpheme dictionary based on an automatic extraction of a non-registered word according to an embodiment of the present invention;

FIGS. 2 to 5 are flowcharts for describing a method of constructing a morpheme dictionary based on an automatic extraction of a non-registered word according to an embodiment of the present invention; and

FIGS. 6 to 8 are diagrams illustrating an example in which a system for constructing a morpheme dictionary based on an automatic extraction of a non-registered word is applied to a natural language question answering system according to an embodiment of the present invention.

### DETAILED DESCRIPTION OF EXEMPLARY EMBODIMENTS

The above and other objects, features and advantages of the present invention will become more apparent with reference to exemplary embodiments which will be described hereinafter with reference to the accompanying drawings. However, the present invention is not limited to exemplary embodiments which will be described hereinafter, and can be implemented in various different types. Exemplary embodiments of the present invention are described below in sufficient detail to enable those of ordinary skill in the art to embody and practice the present invention. The present invention is defined by claims.

Meanwhile, the terminology used herein to describe exemplary embodiments of the invention is not intended to limit the scope of the invention. The articles “a,” “an,” and “the” are singular in that they have a single referent, but the use of the singular form in the present document should not preclude the presence of more than one referent. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. Hereinafter, exemplary embodiments of the present invention will be described in detail with reference to the accompanying drawings.

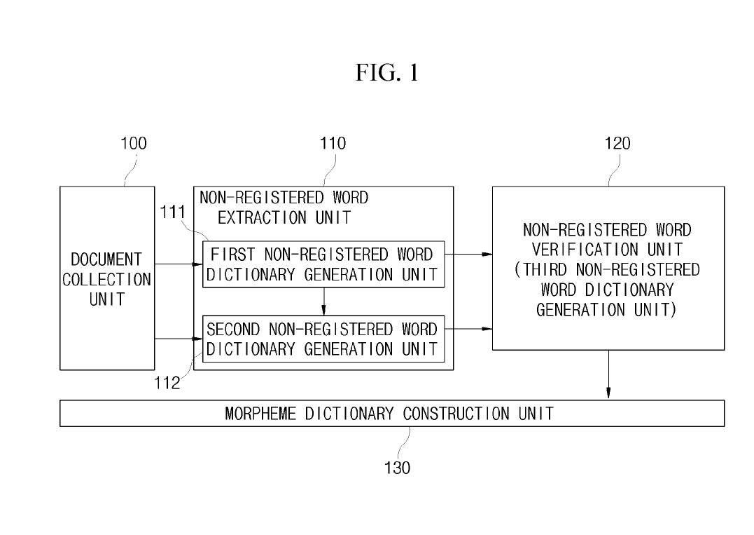

FIG. 1 is a block diagram illustrating a system for constructing a morpheme dictionary based on an automatic extraction of a non-registered word according to an embodiment of the present invention.

A system for constructing a morpheme dictionary based on an automatic extraction of a non-registered word according to an embodiment of the present invention may include a document collection unit 100, a non-registered word extraction unit 110, a non-registered word verification unit 120, and a morpheme dictionary construction unit 130.

The document collection unit 100 may collect a new document which is daily written in news, Blogs, Tweeter, etc., or collect a document of a new field excluding a field in which a morpheme analyzer is developed. The document collection may be a general function, and is not limited to a specific document or specific collection method.

The non-registered word extraction unit 110 may extract a non-registered word from the document collected by the document collection unit 100, and include a first non-registered word dictionary generation unit 111, and a second non-registered word dictionary generation unit 112.

The first non-registered word dictionary generation unit 111 may extract a non-registered word based on frequency of the non-registered word included in the collected document, extract a token of the same type from the newly collected documents, automatically extract a primary non-registered word based on the frequency of the extracted token, and generate a first non-registered word dictionary.

The second non-registered word dictionary generation unit 112 may extract the non-registered word based on a pattern of the primary non-registered word extracted by the first non-registered word dictionary generation unit 111. The second non-registered word dictionary generation unit 112 may automatically search for a non-registered word appearance sentence based on the primary non-registered word, patternize context information around the non-registered word from the searched sentences, automatically extract a secondary non-registered word by applying the generated pattern to the collected document, and generate a second non-registered word dictionary.

The non-registered word extraction unit 110 may transmit the generated first non-registered word dictionary and second non-registered word dictionary to the non-registered word verification unit 120.

The non-registered word verification unit 120 may generate a third non-registered word dictionary by combining the non-registered words included in the first non-registered word dictionary and the second non-registered word dictionary.

The non-registered word verification unit 120 may prioritize the non-registered words by allocating a weight value in a sequence of a common non-registered word>the secondary non-registered word>the primary non-registered word based on the primary non-registered word and the secondary non-registered word, and generate the third non-registered word dictionary by extracting N high-ranked non-registered words as final non-registered words.

The non-registered word verification unit 120 may transmit the generated third non-registered word dictionary to the morpheme dictionary construction unit 130.

The morpheme dictionary construction unit 130 may construct the morpheme dictionary by assuming that the non-registered word which is automatically extracted is a noun, and verify a new dictionary by automatically estimating a result of performing the morpheme analysis based on the new dictionary. When it is verified that the non-registered word-based new dictionary is helpful, the morpheme dictionary construction unit 130 may generate a new estimation set (a second estimation set) by substituting for nouns of a conventional estimation set (a first estimation set) based on the non-registered word. The morpheme dictionary construction unit 130 may verify whether the performance of the morpheme analysis is finally improved by automatically estimating the result of the new dictionary-based morpheme analysis using the corrected estimation set (the second estimation set).

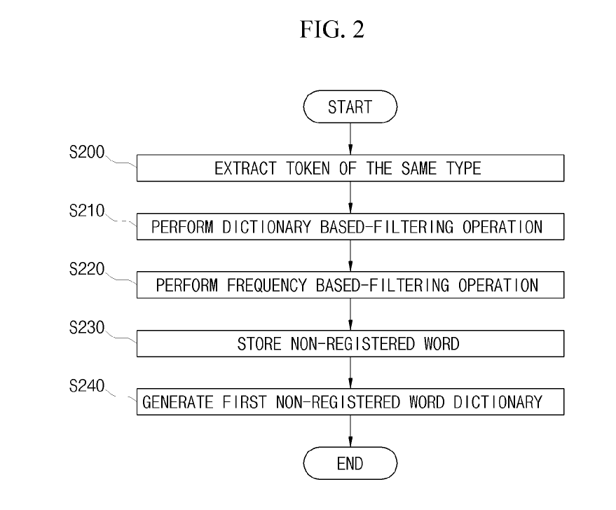

An operation of the system of constructing the morpheme dictionary based on the automatic extraction of the non-registered word will be described in detail with reference to FIGS. 2 to 5.

FIG. 2 is a flowchart for describing an operation of extracting the primary non-registered word based on the frequency of the non-registered word included in the document collected by the first non-registered word dictionary generation unit 111, and generating the first non-registered word dictionary.

The first non-registered word dictionary generation unit 111 may extract the token of the same type from the collected document (S200), perform a dictionary-based filtering operation (S210) and a frequency-based filtering operation (S220) on the extracted token, store the primary non-registered word through the filtering operations (S230), and generate the first non-registered word dictionary (S240).

When extracting the token of the same type from the collected document (S200), the first non-registered word dictionary generation unit 111 may classify the collected document into the token of the same type for each word phrase. The token of the same type may mean a language for each nation, a symbol, etc., and an embodiment of extracting the token of the same type is as follows.

Sentence: The Bank of England (BOE) which is a central bank of England and the Berenberg bank (Germany) feel empathy.

The result of extracting the token for each word phrase with respect to the sentence is as the following Table 1.

TABLE 1

| Word phrase | Token classification result |
|---|---|
| England | England |
| which is a central bank | which is a central bank |
| The Bank of England (BOE) and | The Bank of England |
| | ( |
| | BOE |
| | ) |
| | and |
| Berenberg | Berenberg |
| also bank (Germany) | also |
| | bank |
| | ( |
| | Germany |
| | ) |
| feel empathy. | feel empathy |
| | . |

The first non-registered word dictionary generation unit 111 may perform the dictionary based-filtering operation on the extracted token (S210). The dictionary based-filtering operation may perform a function of removing words which are already registered in the dictionary among the tokens extracted in the operation S200.

The dictionary used in the dictionary-based filtering operation may include a dictionary which is previously constructed for the morpheme analysis or a word dictionary which is constructed as an electronic dictionary, etc., and is not limited to a specific dictionary.

Whether to match with the word which is already registered may be determined by considering both a case in which the token and the word of the dictionary are completely matched and a case in which a portion of the token is registered in the dictionary as the word. Further, since the symbol is not a non-registered word target, the symbol may be unconditionally removed in the operation S210.

A result of the dictionary based-filtering operation according to an embodiment described above is as the following Table 2.

Dictionary words: England, bank, central, Germany, empathy

TABLE 2

| S200: Token list | S210: Dictionary-based filtering result |
|---|---|
| England | |
| which is a central bank | |
| The bank of England | BOE |
| ( | and |
| BOE | |
| ) | |
| and | |
| Berenberg | Berenberg |
| also | also |
| bank | |
| ( | |
| Germany | |
| ) | |
| feel empathy | |
| . | |

When the dictionary based-filtering operation is completed on the extracted token, the frequency filtering operation may be performed on tokens which are remained after being removed in the dictionary-based filtering operation (S220).

In the frequency-based filtering operation, the frequency in the collected document may be calculated with respect to the remaining tokens after being filtered in the operation S210. The frequency may be calculated by considering also a case in which the target token is used as a partial letter of one word phrase. An example of calculating the frequency is as follows.

Collected document (underlined with respect to the token used when calculating the frequency)

The central banks of England and Germany are the BOE and the Berenberg. A foundation year of the BOE is 1901, and the foundation year of the Berenberg is 1920. A founder of the BOE is an English man, and the founder of the Berenberg is also a man . . . of Germany (Deutschland) . . . .

Frequency for each token
BOE: 3
and: 1
Berenberg: 3
also: 3

Only the token in which the frequency is between a minimum value and a maximum value may be remained after calculating the frequency, and remaining tokens may be removed. Optimum values of the maximum value and the minimum value may be found through an experiment, and are not limited to specific values in the present invention.

The frequencies of “and” and “also” are very small since the embodiment described above is a portion of the document for describing an example of calculating the frequency, but actually, a probability which is greater than the maximum value is great since a formal morpheme such as “and” and “also” appears very frequently in the entire document. Therefore, only the BOE and Berenberg may be remained as the tokens through the operation S220.

The first non-registered word dictionary generation unit 111 may store the tokens which are remained through the operation described above as the primary non-registered word (S230), and generate the first non-registered word dictionary (S240). When storing the non-registered word, the token and the frequency information may be stored together. Since a storage format may be freely set, it is not limited in detail in the present invention.

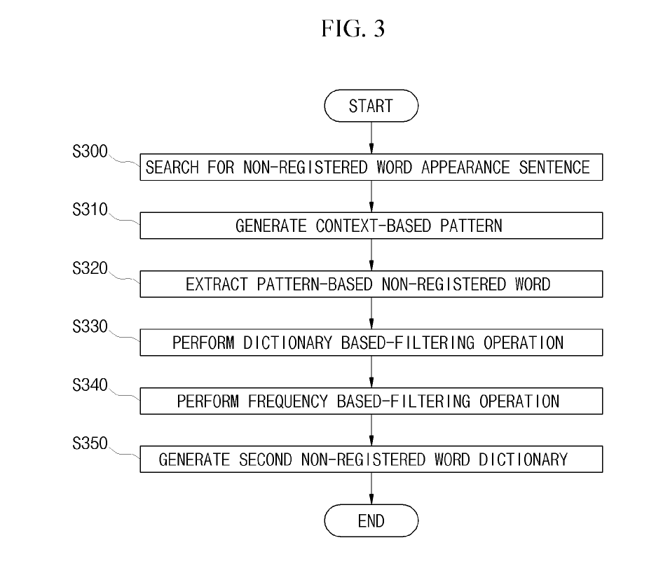

FIG. 3 is a flowchart for describing an operation of extracting the secondary non-registered word based on the pattern of the primary non-registered word included in the first non-registered dictionary by the second non-registered word dictionary generation unit 112.

The second non-registered word dictionary generation unit 112 may search for the sentences in which the primary non-registered words included in the first non-registered dictionary generated by the first non-registered word dictionary generation unit 111 appear (S300). Since the method of searching for the sentence freely uses a searcher which is autonomously implemented or a searcher distributed as an open source, etc., it is not limited to a specific searcher in the present invention.

According to an embodiment described above, an example of a result of a sentence search based on the primary non-registered word included in the first non-registered word dictionary generated by the first non-registered word dictionary generation unit 111 is as the following Table 3.

TABLE 3

| | |
|---|---|
| Non-registered | Result of sentence search |
| word | |
| BOE | This contract has been additionally provided after Top |
| | Engineering Corporation supplies a dispenser to the |
| | BOE in last 2012. |
| Barenberg | An economist of the Barenberg bank has said that “de- |
| | crease of ZEW economic confidence shows a risk of |
| | slowing down Germany and Eurozone economies in the |
| | short term due to Ukraine crisis”. |

The second non-registered word dictionary generation unit 112 may construct context information located in left and right sides of the non-registered word from the searched sentences as a pattern (S310).

A distance of the context information considered as the pattern may not be limited to a specific value in the present invention since the optimum value should be found through the experiment. The pattern may be represented by a formal equation, etc., and be made in a form capable of analyzing autonomously.

An example of the pattern construction with respect to the search result in the operation S300 is as the following Table 4.

TABLE 4

| | |
|---|---|
| Non-registered word | BOE |
| Sentence | This contract has been additionally provided after |
| search result | Top Engineering Corporation supplies a dispenser to |
| | the BOE in last 2012. |
| Pattern result | supplies <token> to <NE> in last <number> year |
| (context | |
| distance: 2) | |

The second non-registered word dictionary generation unit 112 may find the sentence which is matched with the generated pattern when constructing the pattern using the primary non-registered word, and extract the token corresponding to <NE> which is a portion corresponding to an object name as a secondary non-registered word candidate (S320).

An example of the secondary non-registered word extracted based on the pattern is as the following Table 5.

TABLE 5

| | |
|---|---|
| Pattern result | supplies <token> to <NE> in last <number> year |
| (Context | |
| distance: 2) | |
| Sentence | . . . supplies an enamel copper wire to LeeRyuk |
| | Tech in last 2010 . . . |
| | . . . supplies a CCTV apparatus to Rail Network |
| | Authority in last 2011. . . |
| Non-registered | LeeRyuk Tech |
| word candidate | Rail Network Authority |

The second non-registered word dictionary generation unit 112 may perform the dictionary based-filtering operation on the extracted non-registered word when the candidate of the secondary non-registered word is extracted (S330).

Words which are already registered in the dictionary among the non-registered word candidates extracted in the operation S320 may be removed, and the dictionary used in the dictionary based-filtering operation may include the dictionary which is previously constructed for the morpheme analysis or the word dictionary constructed as the electronic dictionary, etc., and is not limited to a specific dictionary. Whether to match with the word which is registered in a conventional dictionary may be determined by considering both a case in which the token and the word of the dictionary are completely matched and a case in which a portion of the token is registered in the dictionary as the word. Further, since the symbol is not a non-registered word target, the symbol may be unconditionally removed in the operation S330.

The second non-registered word dictionary generation unit 112 may perform the frequency-based filtering operation on non-registered words which are remained after the dictionary based-filtering operation is completed (S340).

The frequency in which the non-registered words which are remained appear in the collected document may be calculated, and the non-registered word in which the calculated frequency is between the minimum value and the maximum value may be remained and remaining non-registered words may be removed. Optimum values of the maximum value and the minimum value may be found through the experiment, and are not limited to specific values in the present invention.

The second non-registered word dictionary generation unit 112 may store the non-registered words which are remained through the dictionary based-filtering operation and the frequency based-filtering operation in the second non-registered word dictionary (S350), and repeatedly perform the secondary non-registered word extraction operation described above on the stored non-registered word until the new non-registered word is not found in the collected document.

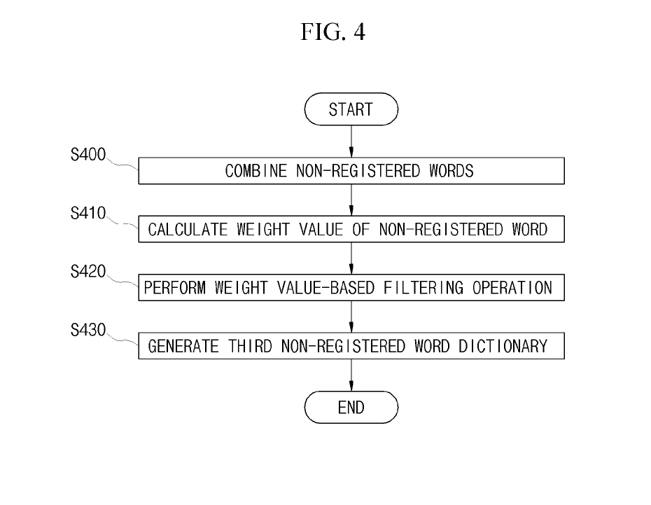

FIG. 4 is a flowchart for describing an operation of combining and verifying the non-registered words generated by the first non-registered word dictionary generation unit 111 and the second non-registered word dictionary generation unit 112.

The non-registered word verification unit 120 may combine the first non-registered word dictionary which is the result of the frequency-based non-registered word extraction and the second non-registered word dictionary which is the result of the pattern-based non-registered word extraction (S400).

The frequencies with respect to the same non-registered word included in both the non-registered words of the first non-registered word dictionary and the second non-registered word dictionary may be added, the added frequency may be stored, and the frequency with respect to the non-registered word included in each of the non-registered words of the first non-registered word dictionary and the second non-registered word dictionary may each be stored.

The non-registered word verification unit 120 may allocate a weight value to the non-registered word combined in the operation S400 (S410), and perform the filtering operation based on the allocated weight value (S420).

The non-registered word verification unit 120 may calculate a score with respect to the combined non-registered word through the following Equations 1, 2, and 3.

Score(UWᵢ^{1,2})=a×Freq(UWᵢ^{1,2}) [Equation 1]

Score(UWⱼ¹)=b×Freq(UWⱼ¹) [Equation 2]

Score(UWₖ²)=c×Freq(UWₖ²) [Equation 3]

Here, UW^{1,2} represents a non-registered word which simultaneously appears in the first non-registered word dictionary and the second non-registered word dictionary, UW¹ represents a non-registered word which appears in the first non-registered word dictionary, and UW² represents a non-registered word which appears in the second non-registered word dictionary. Further, Freq(A) represents the frequency of a non-registered word A, a represents a weight value of UW^{1,2}, b represents a weight value of UW¹, c and represents a weight value of UW². Optimum values of a, b, c which are weight values may be obtained by the experiments, and are set as a>c>b.

The non-registered word verification unit 120 may prioritize every non-registered word based on the score for each non-registered word calculated in the operation S410, extract only N high-ranked non-registered words in which the score is greater than a specific threshold value, and store the extracted N high-ranked non-registered words in the third non-registered word dictionary (S430). Since an optimum value of the threshold value should be obtained according to a field or a kind of the document, the threshold value is not limited to a specific value in the present invention.

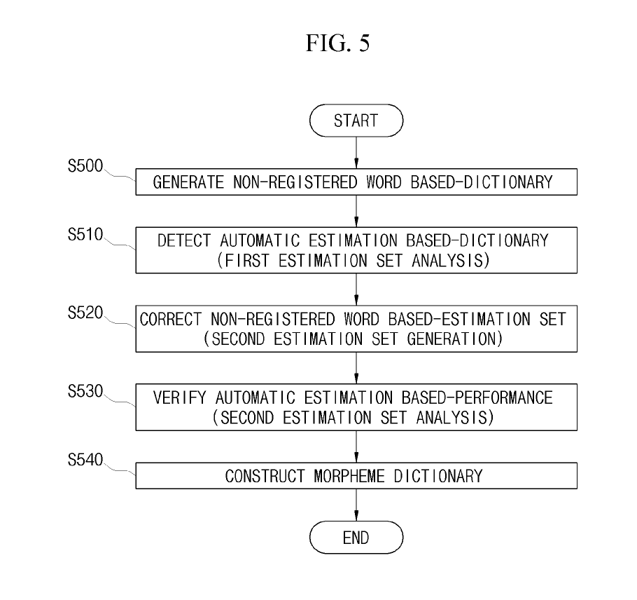

FIG. 5 is a flowchart for describing an operation of constructing the morpheme dictionary using the third non-registered word dictionary constructed through the operation of extracting the non-registered word by the morpheme dictionary construction unit 130, and automatically verifying and storing the constructed morpheme dictionary.

The morpheme dictionary construction unit 130 may reconstruct the third non-registered word dictionary constructed through the operation of extracting the non-registered word in a morpheme dictionary format, and generate the non-registered word-based dictionary (S500).

Since the morpheme dictionary format is not one standardized format, the morpheme dictionary format may be made to be suitable for a morpheme analyzer dictionary format which is used. Since most of non-registered words are nouns in the morpheme analysis in the present invention, the non-registered word which is automatically found may be previously registered in the dictionary as the noun unconditionally. An example of the morpheme dictionary generated through the operation described above is as the following Table 6.

TABLE 6

| | |
|---|---|
| Third non- | LeeRyuk Tech 240.89 |
| registered word | Rail Network Authority110.67 |
| dictionary | . . . |
| Morpheme | LeeRyuk Tech NNG |
| dictionary | Rail Network Authority NNG |

The morpheme dictionary construction unit 130 may automatically estimate performance of the morpheme analysis with respect to a first estimation set using a new morpheme dictionary constructed through the operation S500 (S510).

The first estimation set may use an estimation set which is already set as it is in order to estimate a conventional morpheme analyzer regardless of the newly added non-registered word.

When a partial letter of the format morpheme or the conventional morpheme is erroneously made as the non-registered word, since the performance with respect to the conventional estimation set is lowered, whether the performance of the morpheme analysis is lowered more than before may be estimated when using the morpheme dictionary constructed by the newly extracted non-registered word through this operation. When the estimation performance is lowered more than before, it may be determined that the newly constructed non-registered word has a problem, the newly constructed non-registered word may not be used for the morpheme dictionary and this operation may be ended, and the next operation may be performed only when the performance is the same or is greater.

The morpheme dictionary construction unit 130 may construct a second estimation set which is a new estimation set by converting every noun morpheme of the first estimation set into words of the third non-registered word dictionary when the performance of the morpheme analysis on the first estimation set using the new morpheme dictionary is not lower than before (S520).

An operation of estimating the constructed second estimation set using the new morpheme dictionary may be performed (S530). It may be determined that the new dictionary passes the verification only when the estimation performance in the operation S530 is greater than the performance of the conventional analyzer, and the new dictionary may be constructed as the morpheme dictionary (S540).

The system and method of constructing the morpheme dictionary based on the automatic extraction of the non-registered word described above may support technology such as natural language question answering, information extraction, text mining, text big data analysis, etc. through the performance improvement of the morpheme analyzer.

In detail, for example, a natural language question answering service may be a service of automatically proposing an answer “Battle of Noryang” to a natural language question such as “what is the battle in which Yi Sun-shin died?”.

Since it is important to understand the meaning through the language analysis on the question and the document in the natural language question answering service, the present invention may support a precise question answering service through the performance improvement of the morpheme analysis.

For example, in a question answering system specialized for a specific domain such as sports or medicine, the answer may not be properly extracted when an error of the morpheme analysis is generated on specific words such as “yajanggong” and “kkakkajaengi” to a question of a new field “what is a job called kkakkajaengi when a blacksmith is called yajanggong in North Korea?”. However, the present invention may support so that it is possible to extract the precise answer by automatically extracting “yajanggong” and “kkakkajaengi” which are the non-registered words in the conventional field from the document of the new field as the nouns and constructing the morpheme dictionary.

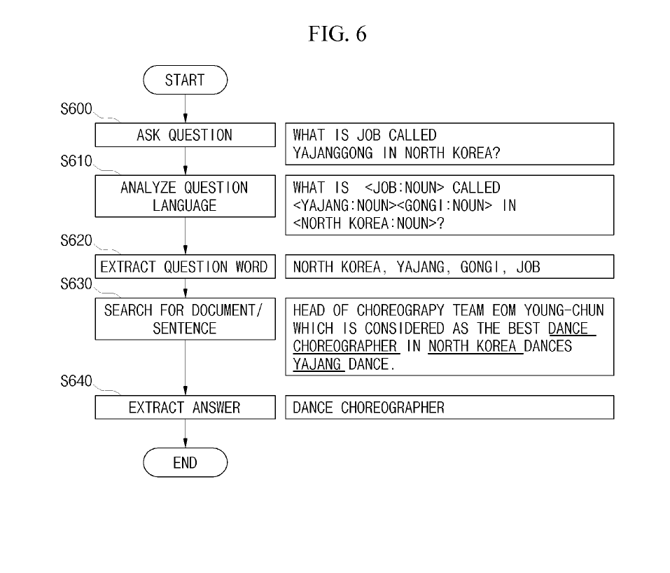

FIGS. 6 to 8 are diagrams illustrating an example of an erroneous analysis of a natural language question answering system, and an example of supporting a natural language question answering service through a system and method for constructing a morpheme dictionary based on an automatic extraction of a non-registered word according to an embodiment of the present invention.

As shown in FIG. 6, when the question “what is the job called yajanggong in North Korea? is received (S600), the result of the morpheme analysis on the question input through the question language analysis may be shown (S610). However, each of “yajang” and “gongi” may be erroneously analyzed as a single noun due to the non-registered word which is called “yajanggong” which does not exist in the conventional field in the question language analysis.

When the question language analysis is completed, the noun may be extracted as the question language (S620), and the document or sentence in which the question language appears may be searched (S630). When the sentence in which “North Korea” and “yajang” appear is searched, an erroneous answer which is “dance choreographer” may be extracted as the answer (S640).

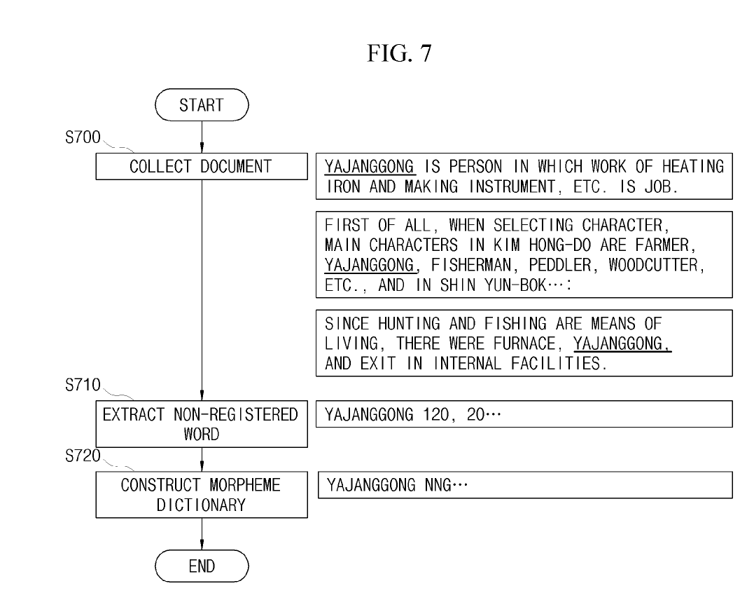

FIG. 7 illustrates an example of automatically extracting “yajanggong” which is the non-registered word by the method proposed in the present invention and generating the morpheme dictionary.

As shown in FIG. 7, the new document may be collected (S700), the non-registered word candidate may be extracted based on the frequency and the pattern from the collected document, and “yaganggong” may be extracted as the non-registered word through the verification operation (S710). The morpheme dictionary may be constructed using the extracted “yaganggong” as the noun (S720).

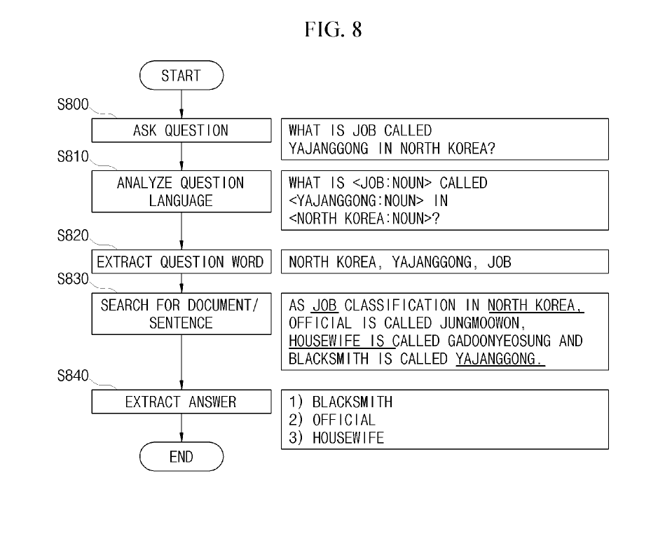

FIG. 8 illustrates an example of extracting the answer in the natural language question answering system using the morpheme dictionary constructed through the operation shown in FIG. 7.

The conventional natural language question answering system may provide the erroneous analysis result in the operation S610 due to the non-registered word, but “yaganggong” may be properly analyzed in the question language analysis by the morpheme dictionary constructed through the operation shown in FIG. 7 (S810). “Yaganggong” may be precisely extracted as the question word (S820), the sentence in which all of “North Korea”, “Job”, and “yaganggong” which are question words appear may be searched (S830), and “blacksmith” which is the answer to the question may be precisely extracted as the answer (S840).

According to the present invention, the problem in which the performance of the morpheme analysis is lowered in the new field can be improved by automatically extracting the non-registered word which appears in the new field and constructing the morpheme dictionary. Further, the performance of the conventional morpheme analyzer can be continuously improved by continuously collecting the new document and continuously expanding/improving the conventional morpheme dictionary.

The above description is merely exemplary embodiments of the scope of the present invention, and it will be apparent to those skilled in the art that various modifications can be made to the above-described exemplary embodiments of the present invention without departing from the spirit or scope of the invention. Accordingly, exemplary embodiments of the present invention are not intended to limit the scope of the invention but to describe the invention, and the scope of the present invention is not limited by the exemplary embodiments. Thus, it is intended that the present invention covers all such modifications provided they come within the scope of the appended claims and their equivalents.

What is claimed is:

1. A system for constructing a morpheme dictionary based on an automatic extraction of a non-registered word, comprising:
a non-registered word extraction unit configured to generate a first non-registered word dictionary based on a frequency of the non-registered word included in a collected document, and generate a second non-registered word dictionary through a pattern analysis of a context including the non-registered word included in the first non-registered word dictionary;
a non-registered word verification unit configured to allocate a weight value to the non-registered word included in the first non-registered word dictionary and the second non-registered word dictionary, and generate a third non-registered word dictionary according to the allocated weight value; and
a morpheme dictionary construction unit configured to perform a morpheme analysis of a first estimation set using the third non-registered word dictionary, generate a second estimation set according to a result of the morpheme analysis, and generate a morpheme dictionary according to a result of the morpheme analysis of the second estimation set.

2. The system for constructing the morpheme dictionary based on the automatic extraction of the non-registered word of claim 1, wherein the non-registered word extraction unit extracts tokens having the same type from the collected document, removes a word which is previously registered in a dictionary among the extracted tokens, and stores the token in which an extracted frequency is within a predetermined range among remaining tokens in the first non-registered word dictionary.

3. The system for constructing the morpheme dictionary based on the automatic extraction of the non-registered word of claim 1, wherein the non-registered word extraction unit searches for a sentence including the non-registered word included in the first non-registered word dictionary, and generates contexts located in left and right sides of the non-registered word in the searched sentence as a pattern.

4. The system for constructing the morpheme dictionary based on the automatic extraction of the non-registered word of claim 3, wherein the non-registered word extraction unit searches for a sentence including the same pattern as the generated pattern, and extracts the non-registered word which is located in the same position as the non-registered word included in the first non-registered word dictionary in the searched sentence.

5. The system for constructing the morpheme dictionary based on the automatic extraction of the non-registered word of claim 4, wherein the non-registered word extraction unit removes a word which is previously registered in a dictionary among the extracted non-registered words, and stores the non-registered word in which an extracted frequency is within a predetermined range among remaining non-registered words in the second non-registered word dictionary.

6. The system for constructing the morpheme dictionary based on the automatic extraction of the non-registered word of claim 1, wherein the non-registered word extraction unit repeatedly performs an operation of generating the first non-registered word dictionary and the second non-registered word dictionary until the non-registered word is not extracted from the collected document.

7. The system for constructing the morpheme dictionary based on the automatic extraction of the non-registered word of claim 1, wherein the non-registered word verification unit calculates a score of each non-registered word by multiplying the frequency of the non-registered word included in the first non-registered word dictionary and the second non-registered word dictionary and the allocated weight value, and stores the non-registered word in which the calculated score is equal to or more than a predetermined value in the third non-registered word dictionary.

8. The system for constructing the morpheme dictionary based on the automatic extraction of the non-registered word of claim 1, wherein the non-registered word verification unit allocates a first weight value to the non-registered word included in both the first non-registered word dictionary and the second non-registered word dictionary, allocates a second weight value which is smaller than the first weight value to the non-registered word included in only the second non-registered word dictionary, and allocates a third weight value which is smaller than the second weight value to the non-registered word included in only the first non-registered word dictionary.

9. The system for constructing the morpheme dictionary based on the automatic extraction of the non-registered word of claim 1, wherein the morpheme dictionary construction unit generates the second estimation set by converting a noun morpheme of the first estimation set into words included in the third non-registered word dictionary when the result of the morpheme analysis of the first estimation set using the third non-registered word dictionary is not lower than a previous analysis result of the first estimation set.

10. The system for constructing the morpheme dictionary based on the automatic extraction of the non-registered word of claim 1, wherein the morpheme dictionary construction unit generates the third non-registered word dictionary as the morpheme dictionary when the result of the morpheme analysis of the second estimation set using the third non-registered word dictionary is greater than a previous analysis result of the second estimation set.

11. A method for constructing a morpheme dictionary based on an automatic extraction of a non-registered word, comprising:
extracting the non-registered word included in a collected document;
verifying the extracted non-registered word, and generating a non-registered word dictionary;
performing a morpheme analysis of a estimation set using the generated non-registered word dictionary; and
constructing the generated non-registered word dictionary as the morpheme dictionary according to a result of the morpheme analysis.

12. The method for constructing the morpheme dictionary based on the automatic extraction of the non-registered word of claim 11, wherein the extracting of the non-registered word included in the collected document comprises:
generating a first non-registered word dictionary based on a frequency of the non-registered word included in the collected document; and
generating a second non-registered word dictionary through a pattern analysis of a context including the non-registered word included in the first non-registered word dictionary.

13. The method for constructing the morpheme dictionary based on the automatic extraction of the non-registered word of claim 12, wherein the generating of the first non-registered word dictionary comprises:
extracting tokens of the same type from the collected document;
removing a word which is previously registered in a dictionary among the extracted tokens; and
generating the first non-registered word dictionary including the token in which the extracted frequency is within a predetermined range among remaining tokens.

14. The method for constructing the morpheme dictionary based on the automatic extraction of the non-registered word of claim 12, wherein the generating of the second non-registered word dictionary comprises:
searching for a sentence including the non-registered word included in the first non-registered word dictionary;
generating contexts located in left and right sides of the non-registered word in the searched sentence as a pattern; and
extracting the non-registered word from a sentence including the same pattern as the generated pattern, and generating the second non-registered word dictionary.

15. The method for constructing the morpheme dictionary based on the automatic extraction of the non-registered word of claim 12, wherein the verifying of the extracted non-registered word and the generating of the non-registered word dictionary allocate a weight value to the non-registered word included in the first non-registered word dictionary and the second non-registered word dictionary, and generate the non-registered word dictionary according to the allocated weight value.

16. The method for constructing the morpheme dictionary based on the automatic extraction of the non-registered word of claim 15, wherein the verifying of the extracted non-registered word and the generating of the non-registered word dictionary calculate a score of each non-registered word by multiplying the weight value allocated to the non-registered word and a frequency of the non-registered word, and generate the non-registered word dictionary including the non-registered word in which the calculated score is equal to or more than a predetermined value.

17. The method for constructing the morpheme dictionary based on the automatic extraction of the non-registered word of claim 15, wherein the verifying of the extracted non-registered word and the generating of the non-registered word dictionary allocate a first weight value to the non-registered word included in both the first non-registered word dictionary and the second non-registered word dictionary, allocate a second weight value which is smaller than the first weight value to the non-registered word included in only the second non-registered word dictionary, and allocate a third weight value which is smaller than the second weight value to the non-registered word included in only the first non-registered word dictionary.

18. The method for constructing the morpheme dictionary based on the automatic extraction of the non-registered word of claim 11, wherein the performing of the morpheme analysis of the estimation set using the generated non-registered word dictionary comprises:
performing the morpheme analysis of a first estimation set using the generated non-registered word dictionary; and
generating a second estimation set by converting a noun morpheme of the first estimation set into the non-registered word included in the non-registered word dictionary when the result of the morpheme analysis is not lower than a previous analysis result of the first estimation set.

19. The method for constructing the morpheme dictionary based on the automatic extraction of the non-registered word of claim 18, wherein the performing of the morpheme analysis of the estimation set using the generated non-registered word dictionary comprises:
performing the morpheme analysis of the generated second estimation set using the generated non-registered word dictionary when the second estimation set is generated.

20. The method for constructing the morpheme dictionary based on the automatic extraction of the non-registered word of claim 19, wherein the constructing of the generated non-registered word dictionary as the morpheme dictionary constructs the generated non-registered word dictionary as the morpheme dictionary when the result of the morpheme analysis of the second estimation set is greater than a previous analysis result of the second estimation set.
